(19) United States
(12) Patent Application Publication
(10) Pub. No.: US 2006/0138374 A1
(43) Pub. Date: Jun. 29, 2006

(54) Solenoid actuated flow control valve including adjustable spacer

(76) Inventors: Michael A. Lucas, Columbus, IN (US); David M. Rix, Columbus, IN (US); David L. Buchanan, Westport, IN (US); Gary Vanderlind, Columbus, IN (US)

Correspondence Address: SAWYER LAW GROUP LLP, P O BOX 51418, PALO ALTO, CA, 94303, US

(21) Appl. No.: 11/304,869

(22) Filed: Dec. 15, 2005

Related U.S. Application Data
(63) Continuation-in-part of application No. 10/823,692, filed on Apr. 14, 2004.

(51) Int. Cl. F16K 31/02

(52) U.S. Cl. 251/129.16

(57) ABSTRACT

A valve actuator assembly is disclosed. The assembly comprises a stator; an armature housing; and an adjustable spacer coupled between the stator and the armature housing, wherein the spacer yields at a controlled rate when an axial load is applied thereto. The adjustable spacer is positioned between the stator and the armature housing such that when an axial load is applied, the adjustable spacer compresses at a controlled rate, thereby allowing adjustment of the valve stroke. A system and method in accordance with the present invention is applicable to any valve which includes a housing containing a seat, an armature, a stator, and a mechanism that is capable of applying a load to the housing.

### CROSS REFERENCE TO RELATED APPLICATIONS

The present application is a continuation-in-part of U.S. patent application Ser. No. 10/823,692, entitled “Solenoid Actuated Flow Controller Valve”, filed Apr. 14, 2004.

### FIELD OF THE INVENTION

The present invention relates generally to a solenoid actuated flow control valve for a fuel system, and more specifically to an adjustable spacer for the actuator stroke of such a valve.

### BACKGROUND OF THE INVENTION

Electromagnetically actuated control valves are widely used in fuel injectors and timing fluid/injection fuel metering systems for precisely controlling the timing and metering of the injected fuel as well as timing fluid. Precise control of the timing and metering of fuel as well as timing fluid is necessary to achieve maximum efficiency of the fuel system of an internal combustion engine. This requires valve designers to consider these performance requirements in their designs.

In a typical fuel system the control valves control the timing and quantity of fuel delivered to the cylinder. The stroke of these control valves affects the quantity and rate shape of injected fuel. A problem with a conventional electromagnetic actuated control valve is that stroke is adjusted manually by grinding a plunger of the valve to a specific length. The process of grinding the plunger is extremely time-consuming by requiring an operator to assemble and disassemble a valve multiple times in the stroke setting operation. In production this issue has been addressed by providing a plurality of class sized plungers which will add considerable expense to the overhead of stocked parts. Even in the most optimized stage providing a plurality of different class sized plungers does not account for gauge error, orifice variation, and seat variation. The combination of these three variables is the largest source of part to part fueling variation for the control valve.

Accordingly, what is needed is a system and method for minimizing the amount of time required for adjusting the stroke of a control valve. The present invention addresses such a need.

### SUMMARY OF THE INVENTION

A valve actuator assembly is disclosed. The assembly comprises a stator; an armature housing; and an adjustable spacer coupled between the stator and the armature housing, wherein the spacer yields at a controlled rate when an axial load is applied thereto. The adjustable spacer is positioned between the stator and the armature housing such that when an axial load is applied, the adjustable spacer compresses at a controlled rate, thereby allowing adjustment of the valve stroke.

The present invention solves the above-identified problem by allowing a valve actuator assembly to be assembled at a nominal high stroke, and then to be adjusted to meet injector performance requirements at the end of line functional test through the use of an adjustable spacer between the armature housing and the stator.

### BRIEF DESCRIPTION OF THE DRAWINGS

FIG. 1A illustrates a perspective view of a solenoid actuated flow controller valve in accordance with the present invention.

FIG. 1B illustrates a valve actuation assembly in accordance with the present invention.

FIG. 1C is a cross-sectional view of a portion of the valve actuator assembly of FIG. 1B.

FIG. 2 is a simplified view of a valve actuator assembly illustrating the deflection of the spacer that allows for the change in valve stroke.

FIG. 3 illustrates a preferred embodiment of the adjustable spacer in accordance with the present invention.

FIG. 4 shows the performance of the adjustable spacer at a controlled rate.

FIGS. 5a and 5b show fueling delivery curves.

### DETAILED DESCRIPTION

The present invention relates generally to a solenoid actuated flow control controller valve for a fuel system, and more specifically to an adjustable spacer for the actuator stroke of such a valve. The following description is presented to enable one of ordinary skill in the art to make and use the invention and is provided in the context of a patent application and its requirements. Various modifications to the preferred embodiments and the generic principles and features described herein will be readily apparent to those skilled in the art. Thus, the present invention is not intended to be limited to the embodiments shown, but is to be accorded the widest scope consistent with the principles and features described herein.

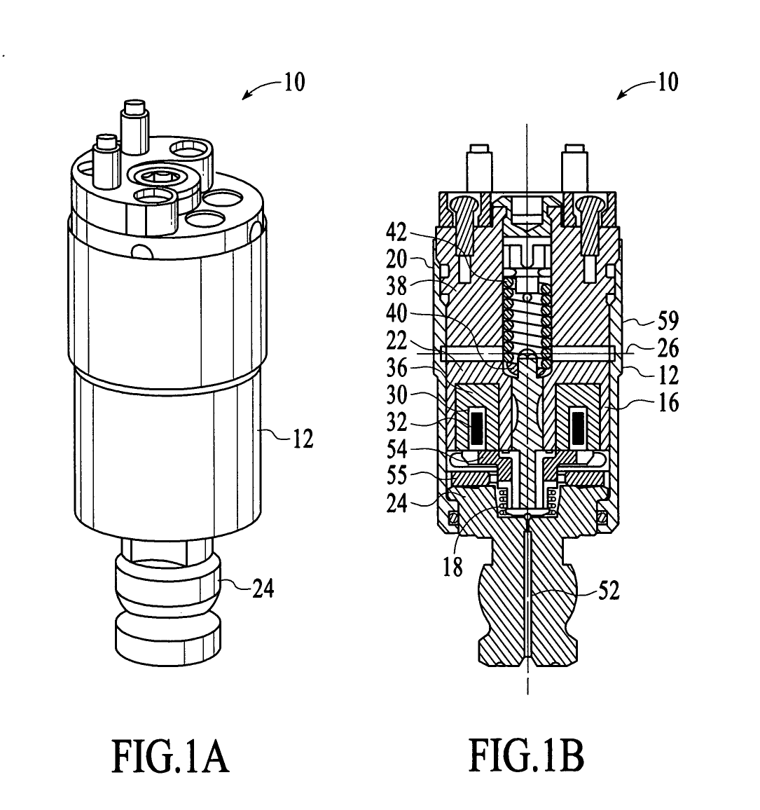

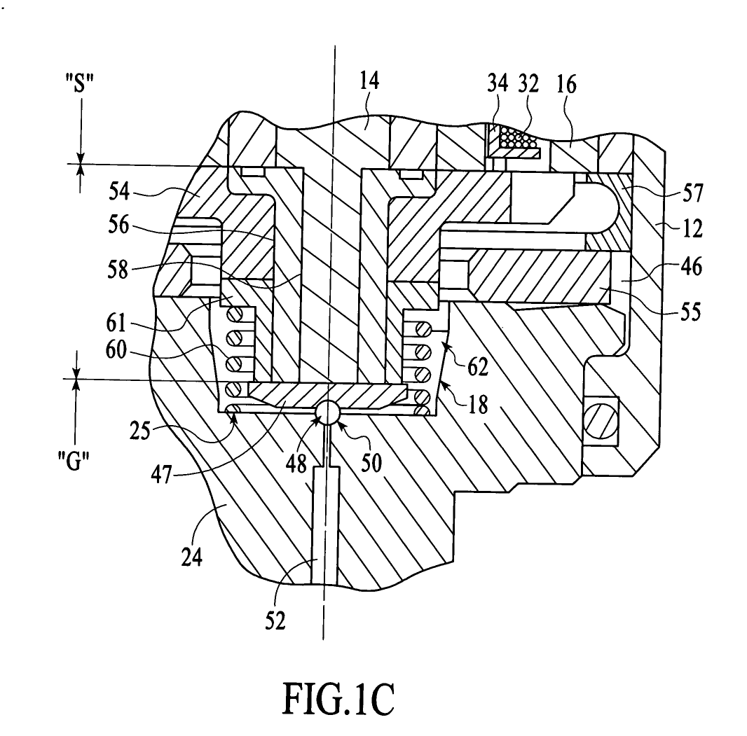

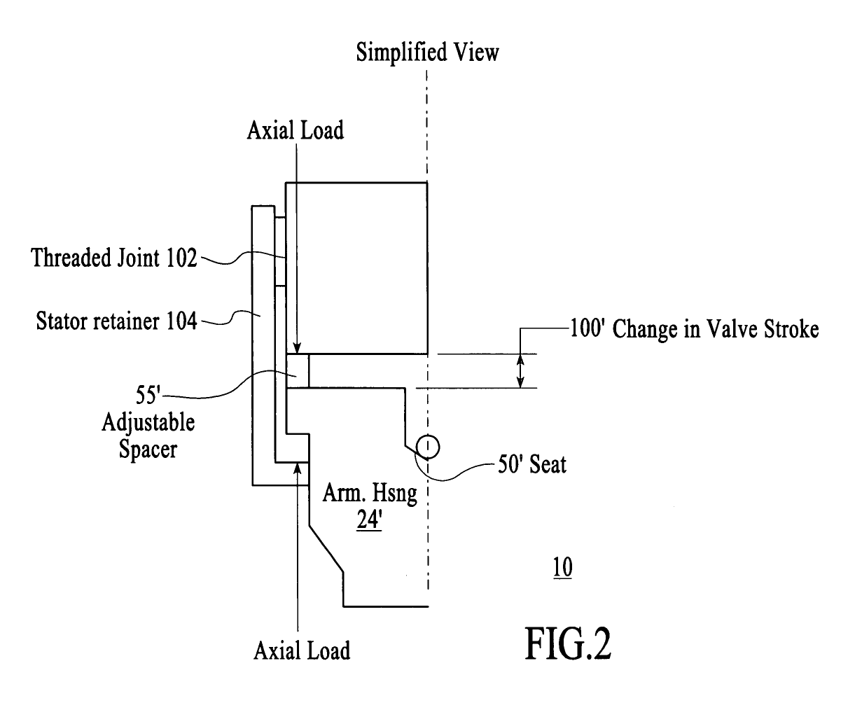

FIG. 1A illustrates a perspective view of a solenoid actuated flow controller valve 10 in accordance with the present invention. This perspective view shows the valve housing 12 and the armature housing 24.

FIG. 1B illustrates a valve actuator assembly in accordance with the present invention.

FIG. 1C is a cross-sectional view of a portion of the valve actuator assembly in accordance with the present invention.

As shown in the cross sectional views of FIGS. 1B and 1C, flow controller valve 10 generally includes valve housing 12, valve plunger 14 mounted for reciprocal movement in valve housing 12, valve actuator assembly 16 for selectively moving valve plunger 14 between extended and retracted positions, and an armature overtravel feature indicated generally at 18.

Valve housing 12 includes upper portion 20 containing cavity 22 and lower armature housing 24 mounted in compressive abutment against a lower surface of upper portion 20. Upper portion 20 may include fuel passages 26 extending radially therethrough for communication with respective fuel passages for delivering fuel, for example, from a drain fuel source to an injector body and nozzle assembly (not shown) mounted adjacent to armature housing 24. In this regard, flow control valve 10 is preferably utilized in a fuel system and is readily positionable in the upper portion of a fuel injector (not shown).

Valve actuator assembly 16 includes solenoid assembly 30 having coil 32 mounted on bobbin 34 and extending around stator assembly 36. Solenoid assembly 30 is positioned in cavity 22 and securely attached to upper portion 20 of valve housing 12, preferably, by a metallic stator body 38. Valve plunger 14 is mounted for reciprocal movement in an aperture extending through stator body 38. A spring retainer and stop device 40 is mounted on an outer end of valve plunger 14 for receiving bias spring 42 for biasing valve plunger 14 downwardly as shown in FIG. 1B.

Valve actuator assembly 16 includes recess cavity 46 that is open toward coil 32 and stator assembly 36, and houses armature 54, adjustable spacer 55, solenoid spacer 57, and components of overtravel feature 18. Valve plunger 14 extends through recess cavity 46.

U.S. patent application Ser. No. 10/823,692, entitled “Solenoid Actuated Flow Controller Valve”, and assigned to the assignee of the present invention, illustrates this feature and is incorporated by reference herein. The present invention is directed to the use of the adjustable spacer 55 to provide for the adjustment of the actuator valve stroke.

The problem with a conventional electromagnetic actuated control valve is that stroke is adjusted manually by grinding a plunger of the valve to a specific length. The process of grinding the plunger is extremely time-consuming by requiring an operator to assemble and disassemble a valve multiple times in the stroke setting operation. In production this issue has been addressed by providing a plurality of class sized plungers which will add considerable expense to the overhead of stocked parts.

The present invention solves the above-identified problem by allowing a valve actuator assembly to be assembled at a nominal high stroke, and then to be adjusted to meet injector performance requirements at the end of line functional test through the use of an adjustable spacer between the armature housing and the stator. The process allows all of the variables to be corrected, reducing assembly time and cost.

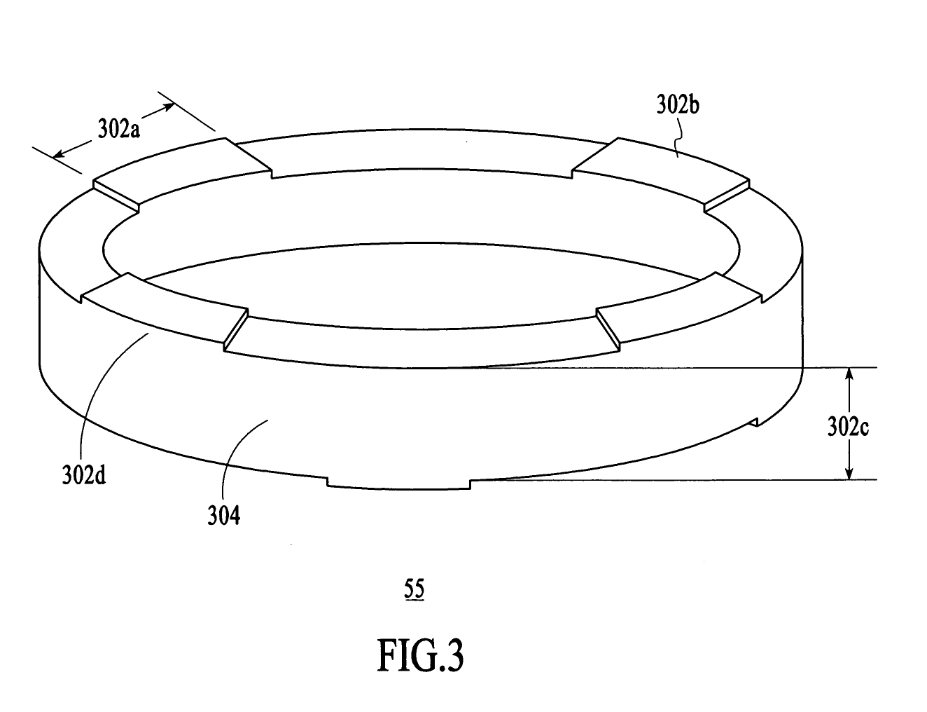

FIG. 2 is a simplified view of a valve actuator assembly illustrating the deflection of the spacer that allows for the change in valve stroke. The valve actuator assembly 10 includes an armature housing 24′ containing a seat 50′, an armature (not shown), an adjustable spacer 55′, a valve plunger 14′ biased against the armature by a load, and a stator assembly 36′. A stator retainer 102 is coupled to the stator assembly 36′ via a threaded joint 104. When an axial load is applied to the stator assembly 36′, the adjustable spacer 55′ yields in a controlled manner shown by the deflection 100 allowing the stroke to decrease with load.

As before mentioned, the adjustable spacer 55′ is positioned between the stator assembly 36′ and the armature housing 24′, and is designed such that when an axial load is applied, the adjustable spacer 55′ yields at a controlled rate, thereby allowing adjustment of the valve stroke (i.e., the gap between the ball valve (not shown) and its valve seat 50′. To describe the features of embodiment of the spacer 55′ in more detail refer now to the following description in conjunction with the accompanying figures.

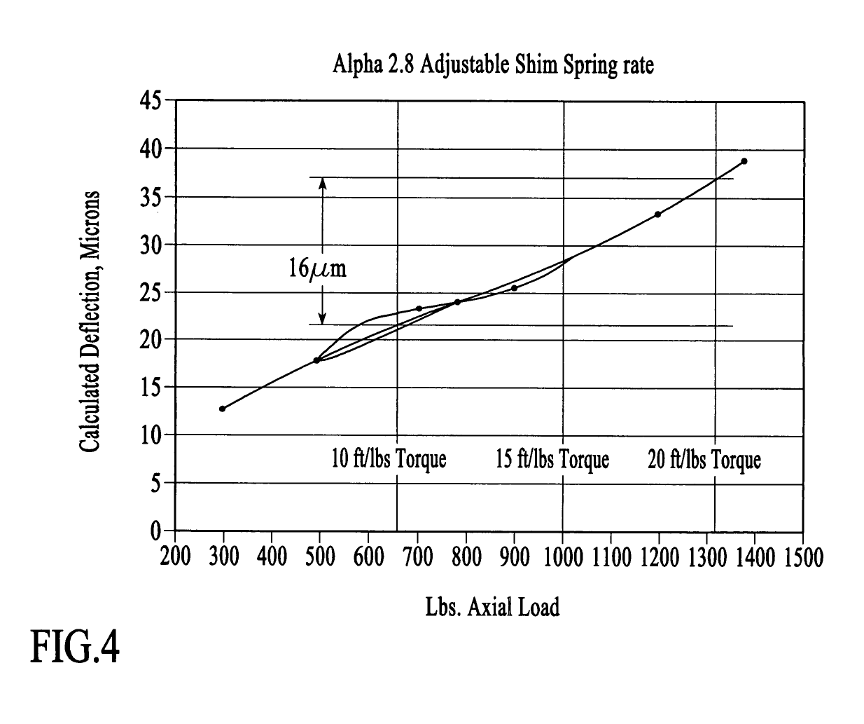

FIG. 3 illustrates a preferred embodiment of the adjustable spacer 55′ in accordance with the present invention. The adjustable spacer 55′ is designed to yield at a controlled rate to allow the valve stroke (gap between ball valve and seat) to be adjusted. In this preferred embodiment, the adjustable spacer 55 has a ring-spaced design with raised pads 302a-d equally spaced apart the main body 304 of the spacer 55′, spaced apart an equal distance from each other, thereby allowing for compression in response to an axial force. In this embodiment, there are four pads 302a-302d. However, it is readily apparent that any number of pads could be utilized and they would be within the spirit and scope of the present invention. The width of the pads 302a-d, the thickness of the spacer 55′, and the materials used are factors which affect the compressibility of the spacer. For example, the materials could be a polymeric-elastomer, spring steel, or other material with a predictable rate of compressible deflection.

It should also be understood there are a variety of other configurations and types of spacers that could be utilized and there use would be within the spirit and scope of the present invention. The main feature of the adjustable spacer is that it can be compressed in a controlled manner to allow for adjustment of the valve stroke.

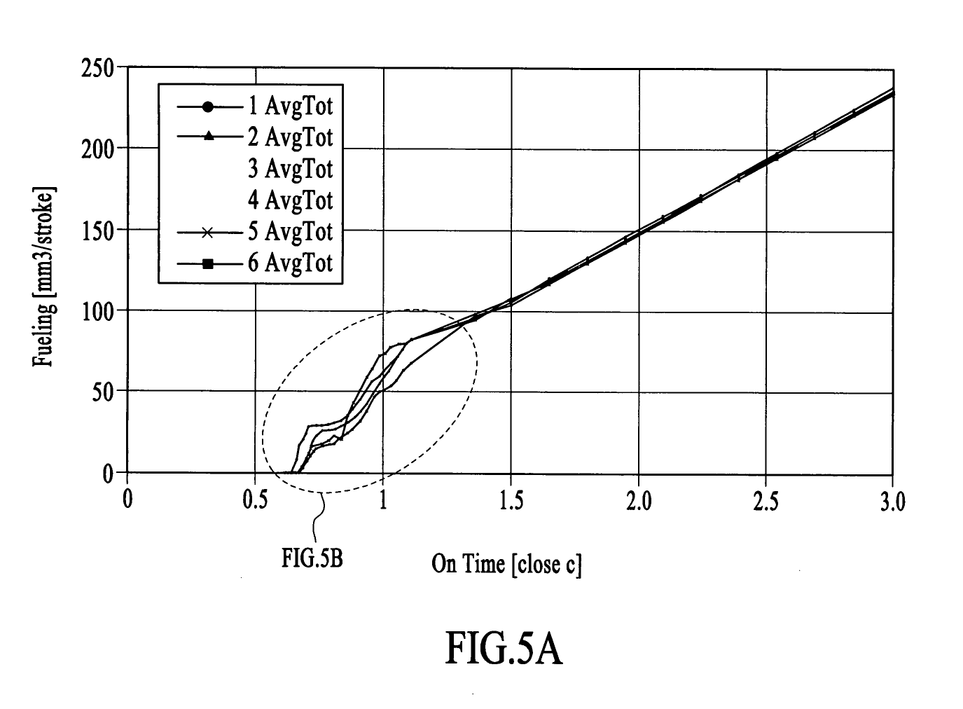

FIG. 4 shows the performance of the adjustable spacer 55′ at a controlled rate as is seen in the compression of the spacer can be controlled to provide the appropriate fuel delivery.

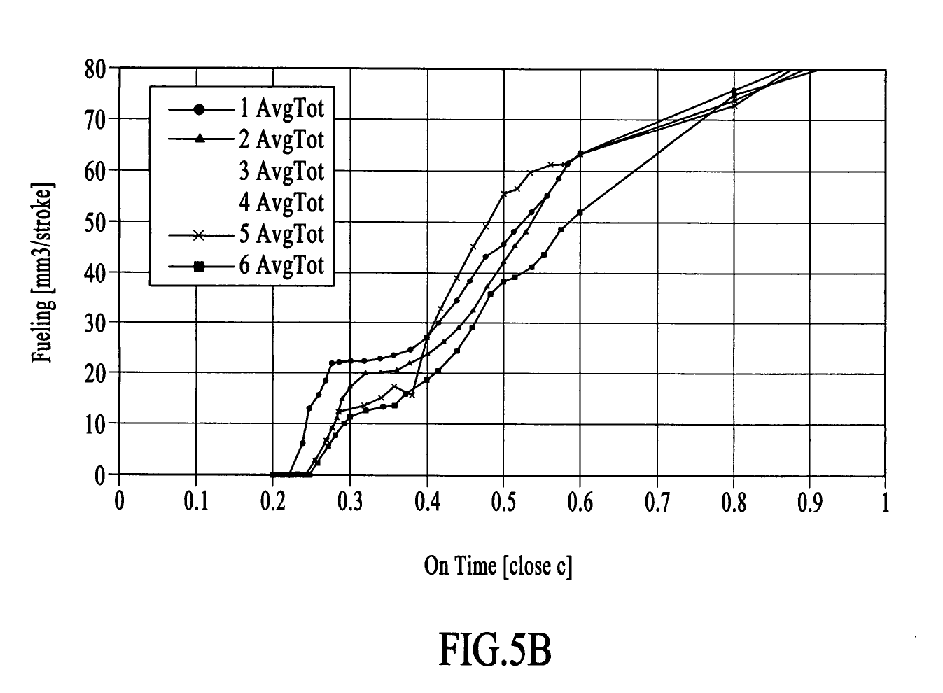

FIGS. 5A and 5B show fueling delivery curves utilizing the spacer 55′. There was no trim, about 10 mm 3 fueling spread, and a 50 usec. spread in start of opening time. Utilizing the adjustable spacer on an on-rig adjustment, injector to injector fueling and opening time variation can be greatly reduced, as shown in the fueling curves in FIGS. 5a and 5b.

Although the present invention has been described in accordance with the embodiments shown, one of ordinary skill in the art will readily recognize that there could be variations to the embodiments and those variations would be within the spirit and scope of the present invention. For example, although a ring shaped adjustable spacer is shown, the spacer could be in a variety of shapes and the spacer would be within the spirit and scope of the present invention. In addition, the spacer could be a spring or the like and its use would be within the spirit and scope of the present invention. Accordingly, many modifications may be made by one of ordinary skill in the art without departing from the spirit and scope of the appended claims.

What is claimed is:

1. A valve actuator assembly comprising:
a stator assembly;
an armature housing; and
an adjustable spacer coupled between the stator assembly and the armature housing, wherein the spacer compresses at a controlled rate when an axial load is applied thereto.

2. The valve actuator assembly of claim 1 wherein the adjustable spacer comprises a spring member.

3. The valve actuator assembly of claim 1 wherein the adjustable spacer comprises a ring shaped member, the ring shaped member including a plurality of raised pads thereon.

4. The valve actuator assembly of claim 1 including a ball valve and a seat for the ball valve, wherein the compression of the adjustable spacer allows for the adjustment of a gap between the ball valve and the seat to control the valve stroke.

5. A fueling system for an internal combustion engine comprising:
a plurality of valve actuator assemblies; each of the valve actuation assemblies further comprising:
a stator assembly; an armature housing; and
an adjustable spacer coupled between the stator assembly and the armature housing, wherein the spacer compresses at a controlled rate when an axial load is applied thereto.

6. The fueling system of claim 5 wherein the adjustable spacer comprises a spring member.

7. The fueling system of claim 5 wherein the adjustable spacer comprises a ring shaped member, the ring shaped member including a plurality of raised pads thereon.

8. The fueling system of claim 5 including a ball valve and a seat for the ball valve, wherein the compression of the adjustable spacer allows for the adjustment of a gap between the ball valve and the seat.

9. A method for adjusting a valve stroke in a valve actuator assembly, the valve actuator assembly comprising a stator assembly and an armature housing; the method comprising:
providing an adjustable spacer between the stator assembly and the armature housing;
assembling the valve at a high nominal stroke; and
compressing the adjustable spacer at a controlled rate to control the valve stroke to meet performance requirements.

10. The method of claim 9 wherein the adjustable spacer comprises a ring shaped member, the ring shaped member including a plurality of raised pads thereon.

11. The method of claim 4 including a ball valve and a set for the ball valve, wherein the compression of the adjustable spacer allows for the adjustment of a gap between the ball valve and the seat.

12. A valve actuator assembly comprising:
a stator assembly;
an armature housing;
an adjustable spacer coupled between the stator assembly and the armature housing, wherein the spacer compresses at a controlled rate when an axial load is applied thereto; wherein the adjustable spacer comprises a ring shaped member, the ring shaped member including a plurality of raised pads thereon;
a ball valve; and
a seat for the ball valve, wherein the compression of the adjustable spacer allows for the adjustment of a gap between the ball valve and the seat to control the valve stroke.
